(19) United States
(12) Patent Application Publication
(10) Pub. No.: US 2005/0276480 A1
(43) Pub. Date: Dec. 15, 2005

(54) Handwritten input for Asian languages

(75) Inventors: Dong Li, Beijing (CN); Donghui Zhang, Beijing (CN); Yong Zhang, Beijing (CN)

Correspondence Address: BANNER & WITCOFF LTD.,;ATTORNEYS FOR MICROSOFT, 1001 G STREET , N.W., ELEVENTH STREET, WASHINGTON, DC, 20001-4597, US

(73) Assignee: Microsoft Corporation, Redmond, WA (US)

(21) Appl. No.: 10/870,535

(22) Filed: Jun. 18, 2004

(30) Foreign Application Priority Data
Jun. 10, 2004 (CN) 003797.01015

(51) Int. Cl. G06K 9/18; G09G 5/00

(52) U.S. Cl. 382/185; 345/156

(57) ABSTRACT

A system and process for helping users enter information in an Asian language is described. In some aspects, input for simplified Chinese and other languages is described with respect to handwritten input.

### RELATED APPLICATION INFORMATION

This application claims priority to Chinese Application No. (003797.01015), filed Jun. 10, 2004, entitled “Handwritten Input For Asian Languages”, to Dong Li, Dong-Hui Zhang, and Yong Zhang. The contents of the application are expressly incorporated herein by reference.

### BACKGROUND OF THE INVENTION

1. Technical Field

Aspects of the present invention relate to hardware and software products. More particularly, aspects of the present invention relate to providing users with an improved process for entering information in Asian languages.

2. Description of Related Art

Computing systems exist in a number of languages. These languages include character-based representations and symbol-based representations of words. While the Western 104 key keyboard is widely used around the world, users of symbol-based languages have needed a way to input symbolic while using the limited input that keyboards offer. One way to input symbolic languages is to use an input method editor (IME by the Microsoft Corporation) specific for a language.

Asian textual input is one of the most challenging computing problems existing today. It has been a bottle-neck of Asian language computing. The Asian language character set is continuously growing with every revision to the Unicode standard. For instance, the CJK (Chinese, Japanese, Korean) characters defined in Unicode 2.0 is 20,902 characters. Unicode 3.0 includes 27,484 characters. Extension B further adds 40,771 more characters.

IMEs provide a conversion engine to convert English letters into Asian characters. Generally, the encoding of Asian characters is based on the phonetics of the Asian character. This may include a combination of letters or letters and numbers. At times, one may need to convert English punctuation into the Asian language's punctuation. Further, English text may be combined with Asian text (and/or mixed with symbols, phonetic letters/characters and Asian ideograph (Chinese characters)), thereby requiring the ability to switch between encoding methods quickly and easily.

There are a number of issues associated with previous approaches:
a. While handwriting input is more natural than keyboard input, keyboard input is the primary input mechanism for Asian languages.
b. While handwritten input is generally fast for Chinese characters, keyboard typing of Pinyin letters is slow.
c. Traditional handwriting recognition input needs users to write Chinese characters (East Asian ideograph). Because Chinese characters are composed of many strokes, writing Chinese characters is complicated. Also, current Chinese handwriting recognition input methods need users to write in separate stroke (not cursive) in order to get higher recognition rates (accuracy). In combination, the complexity, the non-cursive writing, and the lower accuracy (based on error correction rates) makes handwriting recognition input speed low.

An improved system is needed that allows users to quickly and easily enter text in Asian languages.

### BRIEF SUMMARY

Aspects of the present invention address one or more of the issues mentioned above, thereby providing a solution to text entry in Asian languages. Aspects of the invention include the ability to enter information using a stylus. These and other aspects are addressed in relation to the Figures and related description.

### BRIEF DESCRIPTION OF THE DRAWINGS

Various aspects of the present invention are illustrated in the attached figures.

FIGS. 1 and 2 show general-purpose computing environments supporting one or more aspects of the present invention.

FIGS. 3 and 4 show various hardware user interface devices that may be used with aspects of the present invention.

FIGS. 5-8 show various user interfaces according to aspects of the present invention.

FIG. 9 shows a user interface for entering handwritten information in accordance with embodiments of the present invention.

FIGS. 10 and 11 show examples of handwritten information.

FIGS. 12-13 show flowcharts in accordance with aspects of the present invention.

### DETAILED DESCRIPTION OF THE DRAWINGS

Aspects of the present invention relate to providing an ability to enter text in Asian languages.

The following is separated into various sections to assist the reader. These headings include: characteristics of ink; terms; general-purpose computing environment; hardware inputs; user interfaces; user interfaces; and hand written user input interfaces.

Characteristics of Ink

As known to users who use ink pens, physical ink (the kind laid down on paper using a pen with an ink reservoir) may convey more information than a series of coordinates connected by line segments. For example, physical ink can reflect pen pressure (by the thickness of the ink), pen angle (by the shape of the line or curve segments and the behavior of the ink around discreet points), and the speed of the nib of the pen (by the straightness, line width, and line width changes over the course of a line or curve). Because of these additional properties, emotion, personality, emphasis and so forth can be more instantaneously conveyed than with uniform line width between points.

Electronic ink (or ink) relates to the capture and display of electronic information captured when a user uses a stylus-based input device. Electronic ink refers to a sequence of strokes, where each stroke is comprised of a sequence of points. The points may be represented using a variety of known techniques including Cartesian coordinates (X, Y), polar coordinates (r, Θ), and other techniques as known in the art. Electronic ink may include representations of properties of real ink including pressure, angle, speed, color, stylus size, and ink opacity. Electronic ink may further include other properties including the order of how ink was deposited on a page (a raster pattern of left to right then down for most western languages), a timestamp (indicating when the ink was deposited), indication of the author of the ink, and the originating device (at least one of an identification of a machine upon which the ink was drawn or an identification of the pen used to deposit the ink) among other information.

Terms

| | |
|---|---|
| Ink | A sequence or set of strokes with properties. |
| | A sequence of strokes |
| | may include strokes in an ordered form. The sequence may be |
| | ordered by the time captured or by where the strokes appear on a |
| | page or in collaborative situations by the author of the ink. Other |
| | orders are possible. A set of strokes may include sequences of |
| | strokes or unordered strokes or any combination thereof Further, |
| | some properties may be unique to each |
| | stroke or point in the stroke |
| | (for example, pressure, speed, angle, and the like). |
| | These properties |
| | may be stored at the stroke or point level, and not at the ink level |
| Ink | A data structure storing ink with or without properties. |
| object | |
| Stroke | A sequence or set of captured points. |
| | For example, when rendered, |
| | the sequence of points may be |
| | connected with lines. Alternatively, |
| | the stroke may be represented as a |
| | point and a vector in the direction |
| | of the next point. In short, a stroke is intended to encompass any |
| | representation of points or segments |
| | relating to ink, irrespective of |
| | the underlying representation of points and/or what connects the |
| | points. |
| Point | Information defining a location in space. For example, the points |
| | may be defined relative to a capturing |
| | space (for example, points on |
| | a digitizer), a virtual ink space |
| | (the coordinates in a space into which |
| | captured ink is placed), and/or display |
| | space (the points or pixels of a |
| | display device). |
| Docu- | Any electronic file that has a viewable |
| ment | representation and content. A |
| | document may include a web page, |
| | a word processing document, a |
| | note page or pad, a spreadsheet, a visual presentation, a database |
| | record, image files, and combinations thereof. |

General-Purpose Computing Environment

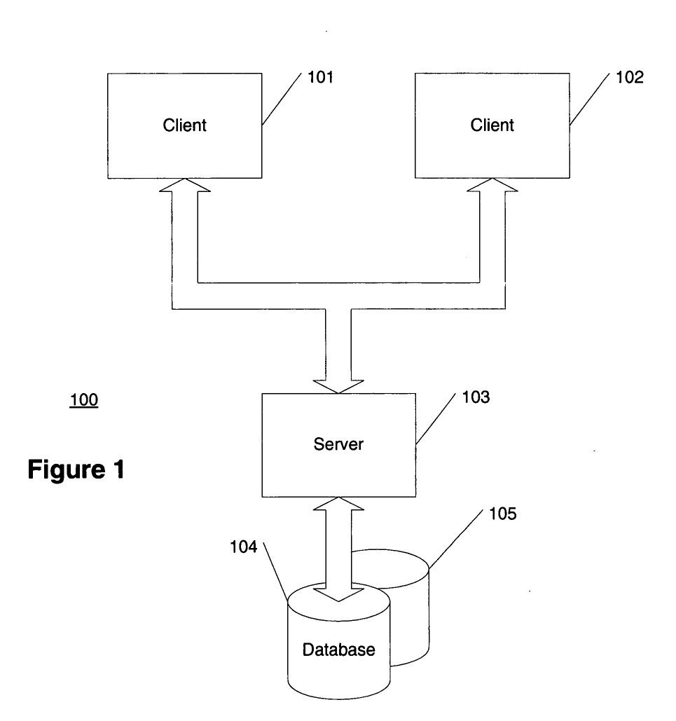

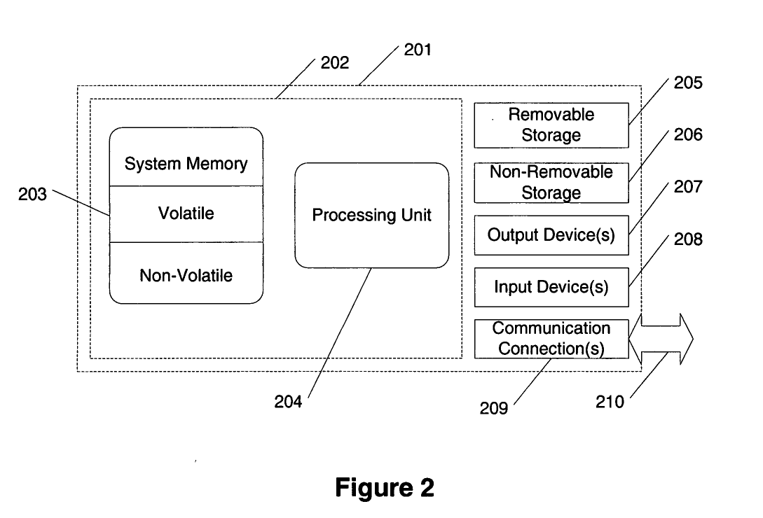

FIGS. 1 and 2 illustrate examples of suitable operating environments 100 and 201 in which the invention may be implemented. The operating environments 100 and 201 are only a few examples of suitable operating environments and are not intended to suggest any limitation as to the scope of use or functionality of the invention. Other well known computing systems, environments, and/or configurations that may be suitable for use with the invention include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

Aspects of the invention may be described in the general context of computer-executable instructions, such as program modules, executed by one or more computers or other devices. Generally, program modules include routines, algorithms, programs, objects, components, data structures, etc. that perform particular tasks or implement particular abstract data types. Typically, the functionality of the program modules may be combined or distributed as desired in various embodiments.

Computing device systems 100 and 201 typically include at least some form of computer readable media. Computer readable media can be any available media that can be accessed by server 103 or system 201. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by server 103 or system 201. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

With reference to FIG. 2, an illustrative system for implementing aspects of the invention includes a computing device, such as device 201. In its most basic configuration, device 201 typically includes a processing unit 204 and memory 203. Depending on the exact configuration and type of computing device, memory 203 may be volatile (such as RAM), non-volatile (such as ROM, flash memory, etc.) or some combination of the two. Additionally, device 201 may also have mass storage (removable and/or non-removable) such as magnetic or optical disks or tape 205-206. Similarly, device 201 may also have input devices such 208 (including a mouse, stylus, keyboard, trackball, and the like) and/or output devices 207 such as a display and the like. Other aspects of device 201 may include network connections 209 to other devices, computers, networks, servers, etc. using either wired or wireless media 210. All these devices are well know in the art and need not be discussed at length here.

Hardware Inputs

Various inputs may exist for inputting handwritten information into a system related to aspects of the present invention.

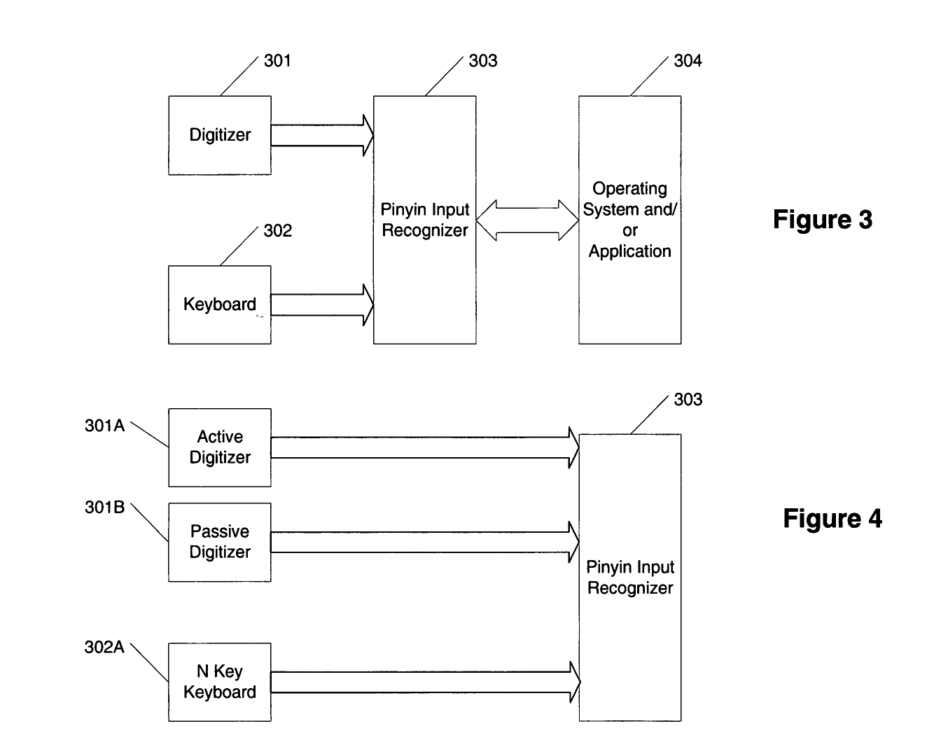

FIG. 3 shows a digitizer 301 receiving handwritten input and forwarding the input to an input recognizer 303, which then forward the recognized input to an operating system and/or application 304. The system may also include a keyboard 302 that receives user input that is forwarded to the input recognizer. Here, the input recognizer 303 may be an IME alone or and IME with additional capabilities. For instance, the input recognizer 303 may include a handwriting recognition engine that recognizes handwriting. If the number of characters is limited that are to be recognized, the recognition accuracy will increase. Here, for example, if using Pinyin, then only 408 characters/combinations need to be recognized. These may be English only, English and simplified Chinese with Chinese characters, or simplified Chinese with Chinese characters.

FIG. 4 shows a modification of FIG. 3. In FIG. 4, various types of digitizers may be used (including an active digitizer 301A and a passive digitizer 301B). Also, aspects of the present invention may use any number of key (N) keyboards 302A. The handwritten inputs may be recognized by a handwriting input recognizer 401. The output of the handwriting recognizer is then recognized by IME recognizer 402. The output from the keyboard 302A may be recognized by the IME recognizer 402.

The system may be used with or without a hardware keyboard. For instance, Pinyin handwriting input may be used with or without a keyboard. For example, one may use a stylus or other pointing device to draw characters or write words that may be recognized by a handwriting recognizer. For instance, one may use electronic ink with various strokes as input to the recognizer. The handwriting recognizer may then be coupled to an IME recognizer to recognize input from the handwriting recognizer.

The handwriting recognizer 401 may be separate from or tied to some aspects of the IME recognizer 402. For instance, handwriting recognizer 401 may recognize strokes or other input based on its predefined recognition information. Alternatively, the handwriting recognizer 401 may use part of a kernel conversion engine of the IME recognizer 402.

User Interfaces

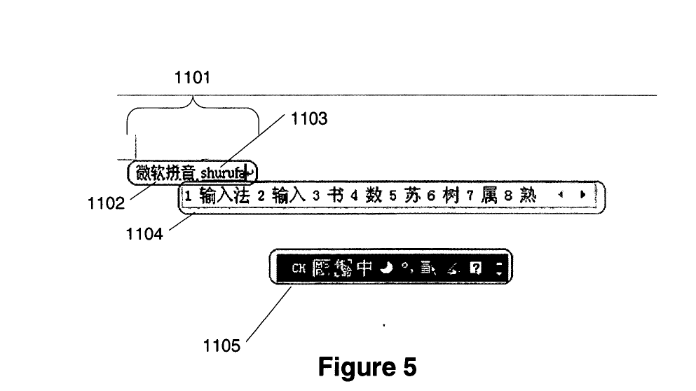

Various user interfaces may be used with the combination of special keys and the IME. FIGS. 5-9 show various user interfaces for use with the pinyin IME. These may be used with a variety of keyboards.

FIG. 5 shows various regions that display information to assist the user compose characters. A composition window is shown as region 1101. Composition window 1101 includes characters that have already been composed 1102 and characters that are being composed 1103. FIG. 5 also includes a candidate window 1104 that shows candidates that match the phonetic sounds of the character in 1103. A user then selects the appropriate candidate and it replaces 1103 and is added to composed characters 1102. Finally, FIG. 5 shows a status bar 1105.

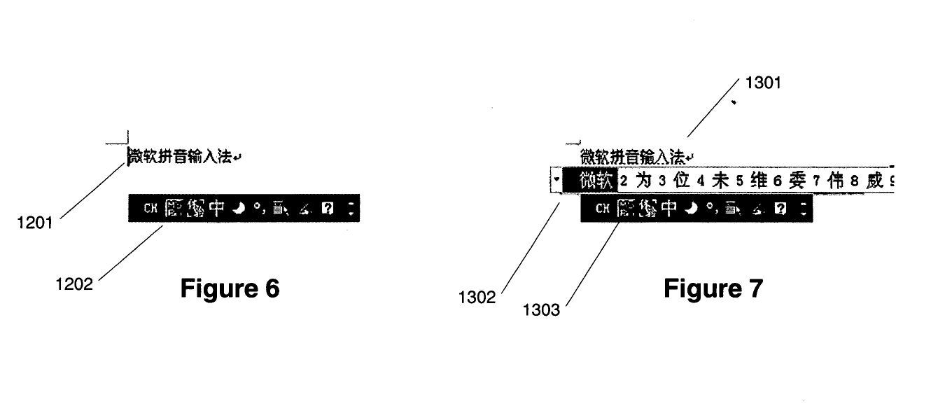

FIG. 6 shows a determined string 1201 and status bar 1202. FIG. 6 shows the user interface before re-conversion. Here, the characters in 1201 have been determined.

FIG. 7 shows a composition window 1301, candidate list 1302, and status bar 1303. After reconversion, the text string from a page is loaded back into a composition window 1301 and the candidate list 1302 displayed. In FIG. 6, the user may be entering text and having the system pick the appropriate character. In FIG. 7, the user is asking the system for an additional opportunity to modify the text to be what the user intends.

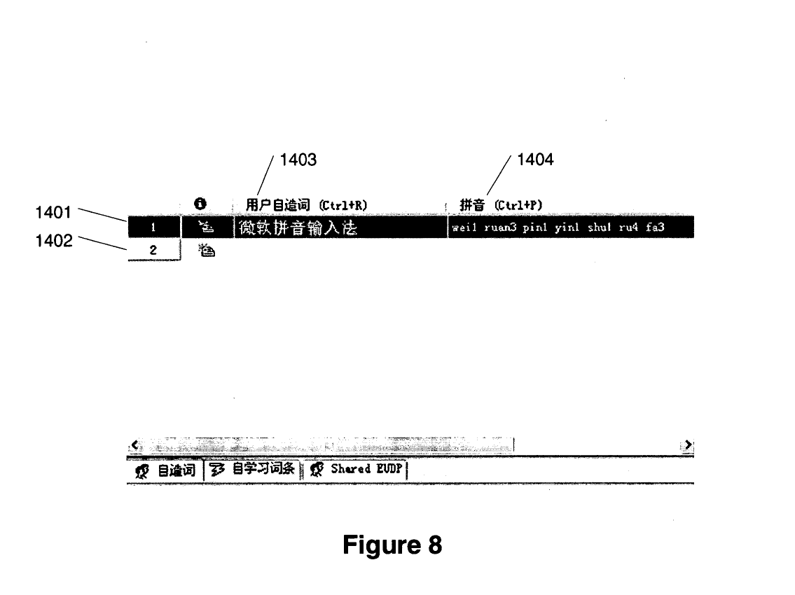

FIG. 8 shows an end user defined phrase tool. Here, a user may enter preferred characters for phonetic inputs. Here, these may be referred to as end user defined phrases. For instance, if one was typing a technical document and one phrase was used more often than others, the user may be provided the ability to specify the character to which the phonetic text should correspond. This allows faster input for the characters.

Handwritten Input User Interfaces

The above sections describe keyboard input of information to be converted. Additional inputs may also be used including handwritten input and speech input. The following describes a phonetic input for composing Asian languages using electronic ink.

In East Asian languages, the languages are composed with CJK (Chinese, Japanese and Korean) characters, but the pronunciation of the language is represented by various phonetic schemes. The phonetic schemes are composed of limited phonetic letters. For instance, in Chinese, the phonetic scheme is called pinyin. As described above, the phonetic letters are the same as the letters found in English. The valid pinyin without tone is 408 syllables. While the CJK characters are 20,902 in Unicode 2.0, there are more than 80,000 in use in East Asian languages.

Traditional approaches have used stroke recognition of handwritten input. However, these approaches are limited by the complexity of characters and the satisfactory recognition accuracy rate when writing in cursive, especially in note-taking scenarios.

The Chinese keyboard IME converts the pinyin to Chinese characters using a statistical language model as is known in the art. The handwriting recognition described herein converts the handwriting ink of CJK (Characters) into text CJK characters (also referred to character handwriting recognition). Some aspects of the present invention combine handwriting recognition with a Chinese keyboard IME. These aspects combine the natural nature of handwriting input and recognition with the proven efficiency of a keyboard-based IME conversion engine. Compared to writing complex Chinese characters, writing in pinyin (using the English word or character equivalent) is faster because of the reduced number of strokes needed to complete a word or phonetic sound. In other aspects, the writing way may be cursive in the pinyin input, while providing greater recognition accuracy based on the desired character being composed in steps (or phonetic parts) and the limited valid Pinyin vocabulary (408). In short, direct character handwriting recognition is not as popular as keyboard-based IMEs because of issues with accuracy, ease of use and efficiency.

As is known in the art, the East Asian keyboard IME is successful with its language model and algorithm where it converts phonetics (here, pinyin in Chinese) into CJK characters with good accuracy. The phonetic input of pinyin includes a limited input: 26 English letters with 408 valid combinations. Based on this limited vocabulary, a hand writing recognition system is able to recognize the input phonetics and produce usable results.

By combining handwritten input of pinyin, recognition of the handwritten input, and downstream conversion of the pinyin into Chinese characters, one or more of the following may be realized:
Handwritten input of pinyin is easier for users using smaller user interfaces (for example, on handheld computing devices and cell phones;
People forget how to write complete, complex Chinese ideograph characters directly;
In some instances, it is easier to write pinyin (English letters) than writing Chinese characters;
Given its limited vocabulary, systems have a higher recognition rate for pinyin strings than complex Chinese characters.
Cursive handwriting recognition technology is generally successful for Latin letters, while it's not very successful in EA character handwriting technology; and
Pinyin to Chinese character conversion is successful in a keyboard-based IME.

The Pinyin handwriting recognition engine may include one or more recognition components. First, it may include a standard English handwriting recognition engine that recognizes cursive English input. This recognition engine may or may not be limited to a vocabulary set of valid pinyin (for example, 408 Pinyin). This is in comparison to the larger vocabulary of English words. Second, it may include a Pinyin-to-Chinese character conversion engine as relating to a Chinese keyboard IME engine (for instance, the MSPY IME by the Microsoft Corporation). Alternatively, another phonetic to character recognition engine may be used in place of the pinyin IME (for instance, one that converts to any of Japanese, Korean, and Chinese by other inputs).

In addition, the handwriting recognition input (the ability to recognize ideographic Chinese characters that are composed of strokes) relates to the traditional handwritten approach to composing handwritten characters. Here, Pinyin (Phonetic) handwriting input provides an input technique for quickly inputting text (for instance in note-taking scenarios), which combines handwriting recognition technology and also the Phonetic-to-Chinese character conversion technology.

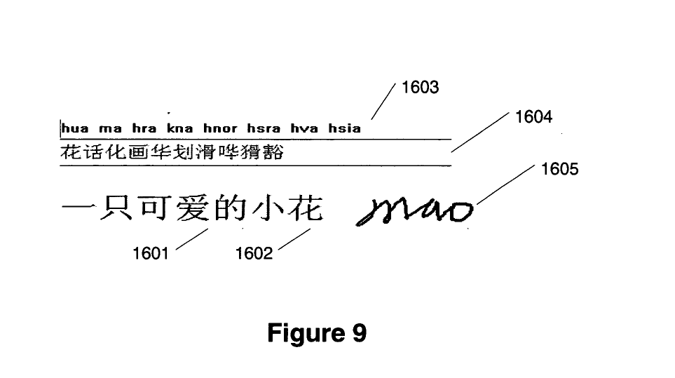

FIG. 9 shows a user interface for use with handwritten input. Region 1601 shows Chinese characters having been converted from pinyin. Region 1602 shows a new candidate based on input handwritten ink. Here, the candidate in region 1602 is the result of handwriting recognition engine whose results are shown in region 1603 (with the English phonetic pinyin string—here, “hua”) and with the Chinese character candidate list in region 1604. Here, region 1602 is populated with the first candidate from region 1604. Region 1605 is where a user may enter new handwritten information. Here, a user has entered an English cursive version of “mao”. Subsequently, candidates for “mao” may appear in region 1603 with their Chinese equivalents in region 1604.

Using the present system, recognition of input in region 1605 may begin when a user lifts a stylus from a contact region, when a user navigates to another area, taps a send button, changes focus, or after a delay has occurred after input of ink in region 1605. Other events may also trigger the recognition of ink in region 1605.

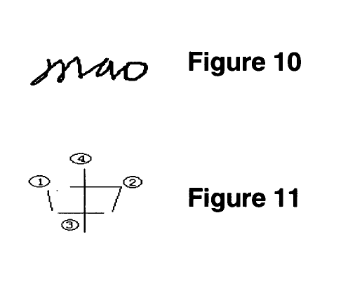

The input in region 1605 may take a number of forms. For instance, it may include English letters (as shown in FIG. 10 with the ink word “mao”) or Chinese character [symbol] in FIG. 11 having four strokes (meaning “zhong1” meaning /within/among/in/middle/center/while (doing sth)/during/China/Chinese/).

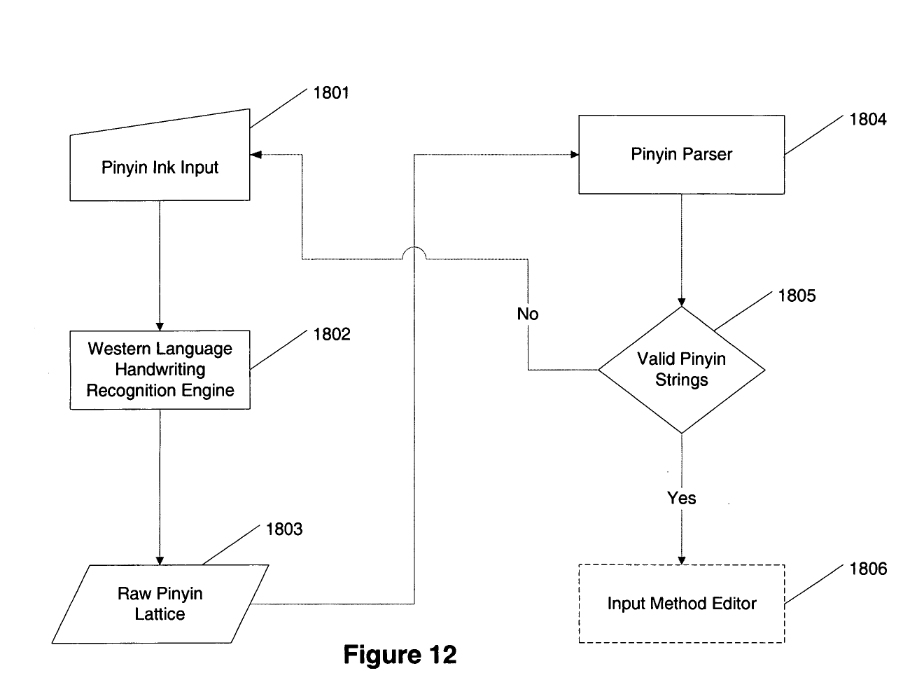

Referring to FIG. 12, the following is an illustrative process for recognizing phonetic handwriting. First, a user starts to input phonetic (Pinyin) by pen. The input is collected into ink strokes in step 1801. A user may also be displayed a tracking of the ink to appear at or near where the stylus (or finger or other pointing implement) contacted a screen or the location of a cursor.

In step 1802, the collected stroke or strokes may be recognized into a raw Pinyin lattice 1803 by, for instance, a western language handwriting recognition engine. When to start recognizing may be definable as described above.

In step 1804, the raw Pinyin lattice is sent to a Pinyin parser 1804 that attempts to generate valid Pinyin strings 1805. If one or more syllables are found or the results equal or exceed a valid Pinyin length limit, then proceed with an IME engine as represented in step 1806. If no valid syllables are found then return to step 1801.

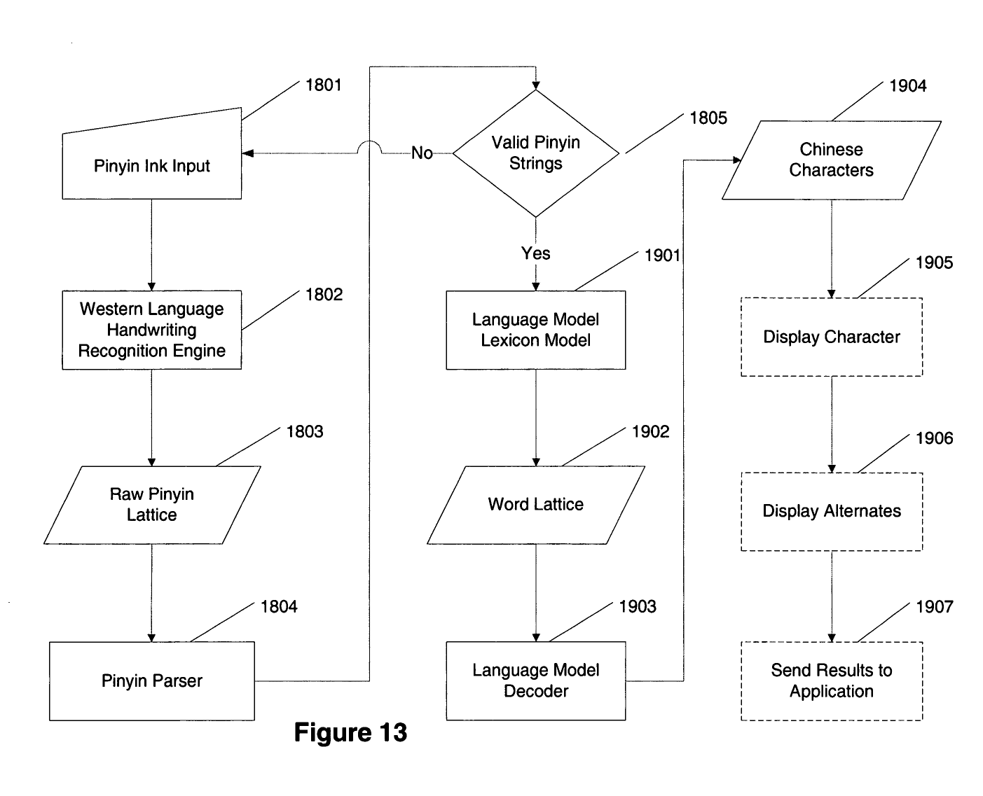

FIG. 13 shows an example of using a language model decoder and other steps with the process of FIG. 12. Continuing from step 1806, the process then uses valid Pinyin strings to build word lattice based on a lexicon in step 1901, resulting in word lattice 1902. The word lattice 1902 is then sent to a language model decoder. The best results from step 1903 are then converted into Chinese characters 1904.

The following steps relate to the display and selection of candidates. They are optional in that all, some, or none may be used in conjunction with practicing the invention. They are shown in broken boxes to highlight their alternative nature. In step 1905, a Chinese character is displayed to a user. This may or may not include modifying the size of a composition window to display its contents to a user. In step 1906, pinyin alternates for a last converted word/character may be shown as well. Also, step 1906 may or may not include the character alternates for a last converted word/character may be displayed. In step 1907, a composition string may be sent to an application upon selection, when instructed to send the character, or when a user navigates away, and the like.

Referring to FIGS. 10 and 11, the system may distinguish between the two input types. If using a cursive input as shown in FIG. 10, then the user may not need to uplift a pen before drawing the next stroke, or writing the next letter. In contrast, in FIG. 11, a user writing in an Asia ideograph may need to uplift a pen before a next stroke is started and recognized.

The following describes various processes among others mentioned above for initiating automatically converting input handwriting into Chinese characters:
If a timer event occurs or
If not in an ink input state.

If so, then the raw Pinyin lattice may then be converted into valid Pinyin strings by Pinyin parser.

The following describes when the process attempts to convert Pinyin strings into Chinese characters:
If multiple valid syllables can be found or
If equal to or exceeding a maximal possible valid Pinyin length.

If so, then the converted Chinese characters may be inserted into composition context, and then both in-line composition window and in-line Ink input window may be adjusted to adapt to a new context.

The following describes when a process may forward Chinese characters into a application:
User pressed one of the specific control buttons/keys, such as “Send” button, etc.
The composition window was full, user can't input additional ink.
A sentence end symbol (punctuation) inputted, such as “!”, is encountered.

The various windows (a composition window, an ink input window, and candidate windows) may or may not be refreshed after context changes.

Results of recognition processes may be displayed in monochrome or may use colors to highlight various error correction behaviors. If colors are used, colors may be used to show Pinyin alternates in a Pinyin candidate window for a current selected word or character (for instance, showing a current word or character—1602—in blue while the rest of the words/characters are shown in black—1601). The user is then able to realize which word in region 1602 is being corrected or for which character alternate choices have been provided in regions 1603 and 1604. Once a user has selected a candidate or corrected a suggested candidate to another candidate, the entire context excepting fixed characters (see below paragraph) may or may not be converted again. This is an attempt to correct various words based on context of the words.

Users may also select a correct alternate to replace a current selected word/character which may or may not be highlighted. In at least one aspect, user selection of an alternate may be marked as “fixed” or already selected or specified. In future conversions, the fixed or previously selected or specified words may remain unchanged while other words/characters are modified to fit the new context.

Aspects of the present invention may also be applied to Japanese, Korean, and traditional Chinese as well. For instance, instead of using a pinyin IME, a developer may include a Japanese, Korean, or traditional Chinese IME as well and add functions to keys as described above.

While IMEs from the Microsoft Corporation may be used with aspects of the present invention, other IMEs may be used as well. For instance, the Unicode IME from International Business Machines and VietIME (Cross-platform Vietnamese Input Method Editor) from Sourceforge.net, to name a few.

Aspects of the present invention have been described in terms of illustrative embodiments thereof. Numerous other embodiments, modifications and variations within the scope and spirit of the appended claims will occur to persons of ordinary skill in the art from a review of this disclosure.

1. A process for inputting characters comprising the steps of:
receiving input from a user, said input including ink; and,
recognizing said ink as a phonetic input;
converting said phonetic input into a character.

2. The process according to claim 1, wherein
said recognizing step recognizes said phonetic input as pinyin.

3. The process according to claim 1, further comprising the step of:
displaying at least one alternate recognition result to said user.

4. The process according to claim 3, wherein said displaying step displays words formed from English letters.

5. The process according to claim 3, wherein said displaying step displays East Asian characters.

6. The process according to claim 3, wherein said displaying step displays a current selection in a color different from unselected characters.

7. The process according to claim 1, wherein
said recognizing step includes use of a Western Language handwriting recognition engine.

8. The process according to claim 1, wherein
said recognizing step includes the step of determining if recognized ink includes at least one valid string.

9. A system for inputting characters comprising:
means for receiving input from a user, said input including ink; and,
means for recognizing said ink as a phonetic input;
means for converting said phonetic input into a character.

10. The system according to claim 9, wherein
said means for recognizing recognizes said phonetic input as pinyin.

11. The system according to claim 9, further comprising:
means for displaying at least one alternate recognition result to said user.

12. The system according to claim 11, wherein said means for displaying displays words formed from English letters.

13. The system according to claim 11, wherein said means for displaying displays East Asian characters.

14. The system according to claim 11, wherein said means for displaying displays a current selection in a color different from unselected characters.

15. The system according to claim 9, wherein
said means for recognizing includes use of a Western Language handwriting recognition engine.

16. The system according to claim 9, wherein
said means for recognizing includes means for determining if recognized ink includes at least one valid string.
